(19) United States
(12) Patent Application Publication
(10) Pub. No.: US 2009/0178479 A1
(43) Pub. Date: Jul. 16, 2009

(54) TILT-INVARIANT FLUID VOLUME MEASUREMENT

(76) Inventors: Talia Pagovich, New York, NY (US); Odelya Pagovich, New York, NY (US); Moshe Eisenberger, Haifa (IL); Gilad Eisenberger, Haifa (IL)

Correspondence Address: DARBY & DARBY P.C., P.O. BOX 770, Church Street Station, New York, NY, 10008-0770, US

(21) Appl. No.: 12/090,533

(22) PCT Filed: Oct. 17, 2006
(86) PCT No.: PCT/IL06/01192

§ 371 Date: Dec. 3, 2008

Related U.S. Application Data
(60) Provisional application No. 60/727,903, filed on Oct. 17, 2005.

(51) Int. Cl. G01F 23/02

(52) U.S. Cl. 73/323

(57) ABSTRACT

Apparatus (20) for measuring a volume of a fluid (38) in a container (24) having a length and a circumference. The apparatus includes one or more gauges (28A, 28B, 28C, 28D) that are configured for coupling to the container. Each gauge includes a hollow, at least partially transparent structure (30, 32, 34) containing a lumen, which is segregated from contact with the fluid in the container and which extends along at least a part of the length and around at least a part of the circumference when the gauge is coupled to the container. A measurement liquid, contained in the lumen, in an amount selected so that a level of the measurement liquid provides a tilt-invariant measurement point (36A, 36B, 36C, 36D) indicative of the volume of the fluid in the container.

### CROSS-REFERENCE TO RELATED APPLICATION

This application claims the benefit of U.S. Provisional Patent Application 60/727,903, filed Oct. 17, 2005.

### FIELD AND BACKGROUND OF THE INVENTION

The present invention relates generally to fluid volume measurement, and particularly to methods and devices for tilt-invariant measurement of fluid volume.

### SUMMARY OF THE INVENTION

In many applications, it is desirable to measure the volume of fluid in a container regardless of the tilt angle of the container. For example, when a baby is fed from a baby bottle, it is sometimes desirable to measure the volume of liquid (e.g. formula, milk or water) remaining in the bottle without removing the bottle from the baby's mouth. Specifically, some newborn babies are fed with regulated, accurately measured volumes of formula, in which case it is particularly important for the feeding parent to be able to correctly measure the amount of formula in the bottle, regardless of the bottle's tilt angle. In general, the bottle can be upright, inverted or oriented in any arbitrary angle.

Embodiments of the present invention provide methods and devices for measuring the volume of fluid in a container invariantly of the tilt angle of the container. Throughout the present patent application and in the claims, the term “fluid” is used in its broadest sense, meaning any fluid substance including but not limited to liquids, gels, slurries, heavy gases and powdered or granulated solids. In some embodiments, the measurement device comprises one or more gauges, each comprising a hollow structure filled with a pre-measured amount of measurement liquid.

The present invention will be more fully understood from the following detailed description of the embodiments thereof, taken together with the drawings in which:

### BRIEF DESCRIPTION OF THE DRAWINGS

FIG. 1 is a schematic side view of a bottle with a fluid volume measurement device, in accordance with an embodiment of the present invention;

FIG. 2 is a schematic, pictorial illustration showing a detail of a fluid volume measurement device; and

FIGS. 3 and 4 are schematic side views of the bottle of FIG. 1, illustrating the operation of the fluid volume measurement device at different tilt angles.

### DETAILED DESCRIPTION OF EMBODIMENTS

FIG. 1 is a schematic side view of a fluid volume measurement device 20, in accordance with an embodiment of the present invention. Device 20 is typically attached, wrapped around, embedded in, or otherwise coupled to a container containing a fluid. In the embodiment shown here, device 20 is wrapped around a baby bottle 24 for the purpose of measuring the volume of fluid (e.g., formula, milk or water) remaining in the bottle. For example, device 20 may have the general form of a cup or sleeve, which fits snugly over the bottle and can be easily transferred from one bottle to another. Alternatively, device 20 may be embedded within the wall of bottle 24 itself, as an integral part of the bottle. In other embodiments, similar volume measurement devices can be adapted, mutatis mutandis, to measure fluid volume in other types of transparent or partially-transparent containers, such as bottles, jars and cans. As noted above, the principles of the present invention are not limited to liquid measurement and can also be used to measure any fluid substance such as, for example, the amount of powder, granulated solid, gel, slurry, gas or other substance remaining in a container.

Device 20 comprises multiple gauges 28A, 28B, 28C, 28D (referred to hereinbelow collectively as gauges 28), which are fixed around bottle 24. Although the embodiment of FIG. 1 uses four such gauges, in alternative embodiments of this present invention, different numbers of gauges may be used, depending on the desired resolution of fluid volume measurement. In one embodiment, a fluid measurement device may comprise only a single gauge of this sort. Each gauge 28 comprises a hollow, at least partially transparent structure, which contains a lumen that extends along at least a part of the length and around at least a part of the circumference of the bottle (or other fluid container). The lumen is segregated from the fluid in the bottle and contains a pre-measured amount of measurement liquid. The level of the measurement liquid provides a measurement point 36 against which the height of a fluid 38 in the container may be compared. As long as the gauge is properly centered along the longitudinal axis of bottle 24, the measurement point remains valid irrespective of the tilt angle of the bottle, as will be explained and demonstrated further hereinbelow.

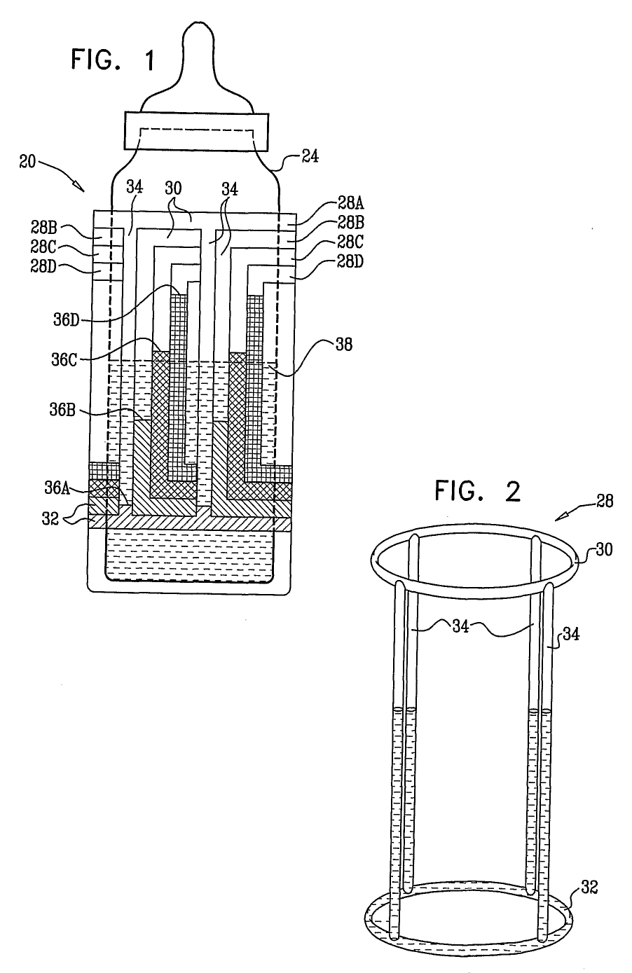

FIG. 2 is a schematic, pictorial illustration showing one of gauges 28, in accordance with an embodiment of the present invention. Each such gauge comprises upper and lower hollow rings 30 and 32 surrounding the container. Rings 30 and 32 are interconnected by longitudinal tubes 34, so as to allow free flow of air and the measurement liquid between the rings and the tubes. In other words, the structure of gauge 28 contains and defines a lumen extending along part of the length and around the circumference of the bottle that is contained within the gauge. Alternatively, other gauge configurations meeting these criteria may be used and are considered to be within the scope of the present invention. The measurement liquid in each gauge is pre-measured so that the height of the measurement liquid corresponds to a predetermined volume of fluid in the container, regardless of the tilt angle of the container. By visually comparing the height of fluid 38 in the container to the height of the measurement liquid in the gauge, the user is able to determine the amount of fluid remaining in the container, irrespective of the tilt angle.

Returning now to FIG. 1, it can be seen that device 20 comprises four gauges 28A, 28B, 28C, 28D, each having the form of the gauge shown in FIG. 2. The gauges are interleaved, so that, for example, rings 30 and 32 of gauge 28B pass beneath longitudinal tubes 34 of gauge 28A; rings 30 and 32 of gauge 28C pass beneath longitudinal tubes 34 of gauges 28A and 28B; and so forth. Thus, some parts of gauges 28B-28D are not visible in the figures because of the partial overlapping between the gauges. Alternatively, other interleaving patterns may be used. In general, the structure of gauges 28 is not limited to interconnected rings and may comprise any hollow structure.

Each gauge 28 is filled with a different amount of measurement liquid (different and separate from the fluid in the container) that corresponds to a predetermined volume of fluid in the container. As a result, gauge 28A gives a measurement point 36A corresponding to about 20% of the volume of bottle 24; gauge 28B gives a measurement point 366B corresponding to about 40%; gauge 28C gives a measurement point 36C corresponding to about 60%; and gauge 28D gives a measurement point 36D corresponding to about 80%. As noted earlier, the actual number of gauges used and the level of measurement liquid in the gauges are determined in accordance with the desired measurement resolution and range. The measurement liquids in the different gauges may have different colors to simplify distinguishing between them in reading the respective measurement liquid levels. The colors are exemplified by different hatching patterns in the figures. (The measurement liquid in gauges 28 may comprise any suitable fluid material that can be observed visually. However, for the sake of simplicity and to clearly distinguish between the substances in the container and in the gauges, the container is referred to as containing a fluid, and the gauges are referred to as containing a measurement liquid.)

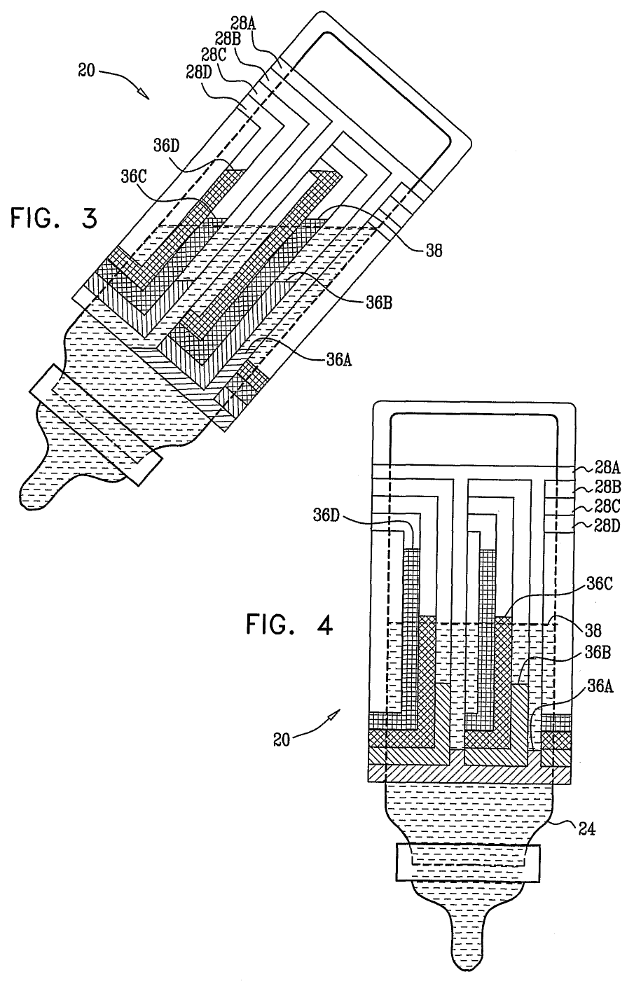

FIGS. 3 and 4 are schematic side views of device on bottle 24 with the bottle held at different tilt angles. It can be seen that measurement fluid flows through gauges 28 in response to the tilt, so that the relationship between measurement points 36A, 36B, 36C and 36D relative to the height of fluid 38 remains invariant regardless of the tilt angle of the bottle. When the bottle is tilted at an arbitrary angle, the measurement liquid in each gauge 28 is free to flow in and between the rings of that gauge via the interconnecting tubes. Therefore, as demonstrated by FIGS. 1-3, the observed level of measurement liquid in each gauge 28 has the same correspondence with the volume of fluid in the container regardless of the spatial angle (tilt) of the container. When a certain gauge 28 is pre-measured so that the level of measurement liquid in that gauge is flush with the fluid level in baby bottle 24 when the bottle is, for example, 50% full, then the measurement liquid in the gauge and the fluid in the bottle will remain flush regardless of the tilt angle of the bottle. As demonstrated in FIGS. 1-3, the level of fluid 38 in bottle 24 is always just below measurement point 36C indicated by the level of measurement liquid in gauge 28C, regardless of the tilt angle of the bottle. Thus, using device 20, a user can visually estimate the volume of fluid remaining in the bottle by observing the gauge whose measurement point 36 is nearest to the level of the fluid in the bottle.

Device 20 thus enables a user, such as a parent feeding a baby, to determine accurately the amount of fluid consumed by the baby while the baby is being fed, without removing the bottle from the baby's mouth. There is also no need for device 20 to come in contact with the fluid in the bottle, and thus no need for cleaning and sterilizing the device after every use. Device 20 permits a parent or caretaker to consistently measure and feed a specific volume of formula to a baby, without interrupting the feeding to check how much fluid is left in the bottle. Use of the device thus ensures that the parent or caretaker can effectively regulate the consumption of formula (or other fluid) by the baby, as well as stopping the feeding if and when required (to burp the baby, for example), with no unnecessary interruptions of the feeding process. The use of device 20 does not require any special skill, training or knowledge.

Although the above embodiment relates specifically to baby bottles and methods for controlling infant feeding, the principles of the present invention may similarly be used in other applications that require measurement of the volume of fluid in a container while the container is tilted or inverted. For example, similar sorts of gauges may be used to measure the amount of fluid remaining in a container while pouring the fluid from the container into a tank of an automobile, machine, or other item of industrial or agricultural equipment. It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. Apparatus for measuring a volume of a fluid in a container having a length and a circumference, the apparatus comprising one or more gauges that are configured for coupling to the container, each gauge comprising:
a hollow, at least partially transparent structure containing a lumen, which is segregated from contact with the fluid in the container and which extends along at least a part of the length and around at least a part of the circumference when the gauge is coupled to the container; and
a measurement liquid, contained in the lumen, in an amount selected so that a level of the measurement liquid provides a tilt-invariant measurement point indicative of the volume of the fluid in the container.

2. The apparatus according to claim 1, wherein the container comprises a baby bottle.

3. The apparatus according to claim 1, wherein the one or more gauges are permanently attached to the container.

4. The apparatus according to claim 3, wherein the container has a wall, and wherein the one or more gauges are integrated within the wall.

5. The apparatus according to claim 1, wherein the one or more gauges are detachable from the container.

6. The apparatus according to claim 1, wherein the structure comprises at least two rings and one or more tubes interconnecting between the rings.

7. The apparatus according to claim 1, wherein the one or more gauges comprise at least first and second gauges, which are filled with respective first and second amounts of the measurement liquid so as to provide different, first and second measurement points with respect to the fluid in the container.

8. The apparatus according to claim 7, wherein the measurement liquid in the first and second gauges is colored with different, respective first and second colors.

9. Apparatus for dispensing a fluid, comprising:
a container, which is at least partially transparent, for containing the fluid, the container having a length and a circumference;
a fluid measurement device, comprising one or more gauges fixed to the container, each gauge comprising:
a hollow, at least partially transparent structure containing a lumen, which is segregated from contact with the fluid in the container and which extends along at least a part of the length and around at least a part of the circumference when the gauge is coupled to the container; and
a measurement liquid, contained in the lumen, in an amount selected so that a level of the measurement liquid provides a tilt-invariant measurement point indicative of the volume of the fluid in the container.

10. The apparatus according to claim 9, wherein the container comprises a baby bottle.

11. The apparatus according to claim 9, wherein the one or more gauges are permanently attached to the container.

12. The apparatus according to claim 11, wherein the container comprises a wall, and wherein the one or more gauges are integrated within the wall.

13. The apparatus according to claim 9, wherein the one or more gauges are detachable from the container.

14. The apparatus according to claim 9, wherein the structure comprises at least two rings and one or more tubes interconnecting between the rings.

15. The apparatus according to claim 9, wherein the one or more gauges comprise at least first and second gauges, which are filled with respective first and second amounts of the measurement liquid so as to provide different, first and second measurement points with respect to the fluid in the container.

16. The apparatus according to claim 15, wherein the measurement liquid in the first and second gauges is colored with different, respective first and second colors.

17. A method for measuring a volume of a fluid in a container having a length and a circumference, the method comprising:
providing one or more gauges, each gauge comprising a hollow, at least partially transparent structure containing a lumen, which is segregated from contact with the fluid in the container, and which contains a measurement liquid in a selected amount; and
coupling the one or more gauges to the container so that the hollow, at least partially transparent structure extends along at least a part of the length and around at least a part of the circumference of the container, such that a level of the measurement liquid in the lumen provides a tilt-invariant measurement point indicative of the volume of the fluid in the container.

18. The method according to claim 17, and comprising comparing a height of the fluid in the container to the level of the measurement liquid while tilting the container to dispense the fluid therefrom in order to determine an amount of the fluid that has been dispensed from the container.

19. The method according to claim 18, wherein the container comprises a baby bottle, and wherein comparing the height comprises determining an amount of the fluid that has been dispensed from the baby bottle into a mouth of a baby without removing the bottle from the mouth.

20. The method according to claim 17, wherein the one or more gauges are permanently attached to the container.

21. The method according to claim 17, wherein providing the one or more gauges comprises fitting the one or more gauges over the container, and removing the one or more gauges from the container after the fluid has been dispensed from the container.

22. The method according to claim 17, wherein the structure comprises at least two rings and one or more tubes interconnecting between the rings.

23. The method according to claim 17, wherein providing the one or more gauges comprises providing at least first and second gauges, which are filled with respective first and second amounts of the measurement liquid so as to provide different, first and second measurement points with respect to the fluid in the container.

24. The method according to claim 23, wherein the measurement liquid in the first and second gauges is colored with different, respective first and second colors.
